(19) United States
(12) Patent Application Publication
(10) Pub. No.: US 2010/0285695 A1
(43) Pub. Date: Nov. 11, 2010

(54) COMBINATION OUTPUT RECEPTACLE AND PLUGS

(76) Inventors: Satoru Ueno, Osaka-shi (JP); Yukihiko Okamura, Hirakata-shi (JP)

Correspondence Address: Cheng Law Group, PLLC, 1100 17th Street, N.W., Suite 503, Washington, DC, 20036, US

(21) Appl. No.: 12/810,423

(22) PCT Filed: Dec. 24, 2008
(86) PCT No.: PCT/JP2008/073475

§ 371 Date: Aug. 2, 2010

(30) Foreign Application Priority Data
Dec. 25, 2007 (JP) 2007-331452

(51) Int. Cl. H01R 27/02

(52) U.S. Cl. 439/639

(57) ABSTRACT

The output receptacle includes a first blade reception member adapted to be supplied with a zero voltage and at least two second blade reception members adapted to be supplied with different voltages. The at least two second blade reception members are arranged to be shaped or located differently from each other. Two-pole blades of each of at least two plugs include a first blade configured to be connected to the first blade reception member, and a second blade. The second blades of at least two plugs are shaped or located differently from each other for connection respectively to the second blade reception members.

### TECHNICAL FIELD

The present invention is directed to a combination output receptacle and plugs, and more specifically to a combination output receptacle and plugs for providing different DC voltages from an output receptacle respectively to different plugs selectively connected to the output receptacle.

### BACKGROUND ART

In the past, there has been proposed a combination output receptacle and plugs (connector) used for connecting a line to a cord, or cords to each other. The combination output receptacle and plugs is capable of easily connecting a line to a cord, or cords to each other, by attaching an attachment plug (plug) to a plug receiving equipment, and/or is capable of easily separating a line from a cord, or cords from each other, by detaching the attachment plug from the plug receiving equipment. Especially, a plug receiving equipment which is fixed to a building part such as a wall, a device, or the like is called “output receptacle (outlet)”.

This kind of the combination output receptacle and plugs, which is called a wiring plug-in connector, includes a plug (attachment plug) having a pair of blades and an outlet receptacle having a pair of blade reception members to be respectively connected to the pair of the blades.

The plug and the output receptacle are designed to be exclusively connected to each other. Therefore, the output receptacle cannot be connected to a plug of the different type. In short, the output receptacle permits a connection of a single type of the plug.

Accordingly, a conversion adapter disclosed in Japanese Non-examined Patent Publication No. 2002-134210 is required for connecting the plug to the output receptacle of the different type from the plug.

### DISCLOSURE OF INVENTION

In view of the above insufficiency, the present invention has been aimed to provide a combination output receptacle and plugs capable of selectively using plugs of different regulations or voltage ratings for connection with a single output receptacle without relying on a conversion adapter, thereby giving flexibility of being adapted to various DC supply voltages with increased versatility.

The combination output receptacle and plugs in accordance with the present invention is configured to provide different DC voltages from an output receptacle respectively to different plugs selectively connected to the output receptacle. Each of the plugs is provided with two-pole blades adapted to be connected respectively to two-pole blade reception members of the output receptacle. The two-pole blade reception members includes a first blade reception member adapted to be supplied with a zero voltage and at least two second blade reception members adapted to be supplied with different voltages. The two-pole second blade reception members are arranged to be shaped or located differently from each other. The two-pole blades of each of the at least two plugs includes a first blade configured to be connected to the first blade reception member, and a second blade. The second blades of at least two plugs are shaped or located differently from each other for connection respectively to the second blade reception members.

According to the present invention, in the case of the output receptacle having the second blade reception members respectively designed for 12V and 48V, the second blade of the plug for 12V is shaped or located for connection with the second blade reception member for 12V while the first blade of the plug for 12V is connected to the common first blade reception member. Further, the second blade of the plug for 24V is shaped or located for connection with the second blade reception member for 24V while the first blade of the plug for 24V is connected to the common first blade reception member. It is possible to selectively connect one or more plugs having different rated voltages to the single output receptacle without use of a conventional conversion adapter.

Other combination output receptacle and plugs in accordance with the present embodiment is configured to provide different DC voltages from an output receptacle respectively to different plugs selectively connected to the output receptacle. Each of the plugs is provided with two-pole blades adapted to be connected respectively to two-pole blade reception members of the output receptacle. The output receptacle is provided with a voltage switch configured to select one of the different DC voltages being supplied across the two-pole blade reception members. The plugs are provided respectively with projections which come into contact with the voltage switch when the two-pole blades are connected to the two-pole blade reception members. The projections of the plugs is shaped or located differently from each other. The voltage switch is configured to select a proper one from the different DC voltage depending on the shape or location of the projection of the plug in contact with the voltage switch.

According to the present invention, in the case of the output receptacle having the voltage switch selecting the blade reception member of the output receptacle from the blade reception member for 12V and 48V, when the plug for 12V is connected to the output receptacle, the projection of the plug presses the voltage switch, thereby selecting 12V for the voltage applied to the blade reception member. When the plug for 24V is connected to the output receptacle, the projection of the plug presses the voltage switch, thereby selecting 24V for the voltage applied to the blade reception member. Therefore, it is possible to selectively connect one or more plugs having different rated voltages to the single output receptacle without increasing the number of the blade reception members. Further, it is possible to select and output the proper voltage corresponding to the specification of the plug by employing a simple configuration where the plug is provided with the projections. Therefore, a complex switch mechanism and manipulating means is unnecessary, and usability is improved.

In a preferred embodiment, the combination output receptacle and plugs includes a plurality of the voltage switches located in differently from each other depending on a DC voltage to be switched. The protrusion is shaped or located to be contacted to the voltage switch corresponding to the proper DC voltage while the blades of the plug are respectively connected to the blade reception members of the output receptacle.

According to this embodiment, it is possible to select and output the proper voltage determined by the regulation or rated voltage of the plug simply by differently locating the plurality of the voltage switches depending on the DC voltage to be switched, and differently shaping or locating the protrusion for contact with the voltage switch corresponding to the proper DC voltage.

Other combination output receptacle and plugs includes a plug including a first blade and a second blade, and an output receptacle configured to be connected to the plug and including a first blade reception member configured to be connected to the first blade of the plug and a second blade reception member configured to be connected to the second blade of the plug. The output receptacle includes a plurality of the second blade reception members. The first blade reception member is adapted to be supplied with a reference potential. The plurality of the second blade reception members is adapted to be supplied with different potentials. The second blade is configured to be connected to any one of the plurality of the second blade reception members in accordance with a rated voltage of the plug.

According to the present invention, when the plug is connected to the output receptacle, the second blade is connected to any one of the plurality of the second blade reception members in accordance with the types of the plug while the first blade is connected to the first blade reception member. Herein, the first blade reception member is adapted to be supplied with the reference potential and the plurality of the second blade reception members is adapted to be supplied with different potentials. Therefore, applied between the first blade and the second blade of the plug is a voltage according to the rated voltage of the plug. Accordingly, it is possible to selectively connect plugs having different rated voltages to the single output receptacle without use of a conversion adapter. Thus, the combination output receptacle and plugs is capable of giving flexibility of being adapted to various DC supply voltages with increased versatility.

Other combination output receptacle and plugs includes a plug including a pair of blades, and an output receptacle including a pair of blade reception members adapted in use to be respectively connected to the pair of blades. The output receptacle includes a voltage selection unit configured to select a DC voltage applied between the blade reception members in the pair. The output receptacle is configured to apply the DC voltage selected by the voltage selection unit between the blade reception members in the pair. The plug includes an operation unit configured to operate the voltage selection unit to select a voltage according to a rated voltage of the plug when the plug is connected to the output receptacle.

According to the present invention, the operation unit selects the DC voltage in accordance with the rated voltage of the plug when the plug is connected to the output receptacle. Therefore, applied between the blades of the pair of the plug is the voltage according to the rated voltage of the plug. Accordingly, it is possible to selectively connect plugs having different rated voltages to the single output receptacle without use of a conversion adapter. Thus, the combination output receptacle and plugs is capable of giving flexibility of being adapted to various DC supply voltages with increased versatility. Further, because the output receptacle varies the voltage applied between the blade reception members in the pair, the number of the blade reception members need not be increased.

In a preferred embodiment, the voltage selection unit includes a plurality of voltage switches and is configured to select the DC voltage in accordance with on/off states of each of the voltage switches. The operation unit is configured to switch the on/off states of the voltage switches when the plug is connected to the output receptacle.

According to this embodiment, the selection of the DC voltage of the output receptacle in accordance with the rated voltage of the plug can be realized by a simple configuration where the plug is provided with the projections. Therefore, a complex switch mechanism and manipulating means is unnecessary, and usability is improved. Further, the DC voltage can be varied in line with the rated voltage of the plug by simple arrangement of the voltage switches of the voltage selection unit and/or the operation unit.

### BRIEF DESCRIPTION OF DRAWINGS

FIG. 1A is a perspective view illustrating an output receptacle of a combination output receptacle and plugs in accordance with a first embodiment,

FIG. 1B is a perspective view illustrating a plug adapted for 12V of the above combination output receptacle and plugs,

FIG. 1C is a perspective view illustrating a plug adapted for 24V of the above combination output receptacle and plugs,

FIG. 1D is a perspective view illustrating a plug adapted for 48V of the above combination output receptacle and plugs,

FIG. 2A is a schematic view illustrating an internal configuration of the output receptacle of the above combination output receptacle and plugs,

FIG. 2B is a schematic view illustrating an internal circuit of the output receptacle of the above combination output receptacle and plugs,

FIG. 3A is a perspective view illustrating an output receptacle of a combination output receptacle and plugs in accordance with a second embodiment,

FIG. 3B is a front view illustrating the output receptacle of the above combination output receptacle and plugs,

FIG. 3C is a front view illustrating a plug adapted for 12V of the above combination output receptacle and plugs,

FIG. 3D is a front view illustrating a plug adapted for 24V of the above combination output receptacle and plugs,

FIG. 3E is a front view illustrating a plug adapted for 48V of the above combination output receptacle and plugs,

FIG. 4A is a perspective view illustrating an output receptacle of a combination output receptacle and plugs in accordance with a third embodiment,

FIG. 4B is a perspective view illustrating a plug adapted for 24V of the above combination output receptacle and plugs,

FIG. 4C is a perspective view illustrating a plug adapted for 48V of the above combination output receptacle and plugs,

FIG. 5A is an explanatory view illustrating a condition of the above output receptacle before being connected to the plug,

FIG. 5B is an explanatory view illustrating the condition of the above output receptacle before being connected to the plug adapted for 24V,

FIG. 5C is an explanatory view illustrating the condition of the above output receptacle after being connected to the plug adapted for 24V,

FIG. 5D is an explanatory view illustrating the condition of the above output receptacle before being connected to the plug adapted for 48V,

FIG. 5E is an explanatory view illustrating the condition of the above output receptacle after being connected to the plug adapted for 48V,

FIG. 6 is a perspective view illustrating a primary part of the output receptacle of the above combination output receptacle and plugs,

FIG. 7A is a schematic view illustrating an internal configuration of the output receptacle of the above combination output receptacle and plugs,

FIG. 7B is a schematic view illustrating an internal circuit of the output receptacle of the above combination output receptacle and plugs,

FIG. 7C is a schematic view illustrating the above internal circuit of another instance,

FIG. 8A is a perspective view illustrating an output receptacle of a combination output receptacle and plugs in accordance with a fourth embodiment,

FIG. 8B is a front view illustrating the above output receptacle,

FIG. 8C is a front view illustrating a plug of the above combination output receptacle and plugs,

FIG. 8D is an explanatory view illustrating an operation of the above combination output receptacle and plugs,

FIG. 8E is an explanatory view illustrating an operation of the above combination output receptacle and plugs of another instance,

FIG. 9A is a schematic view illustrating a configuration of voltage switches of the output receptacle of the above combination output receptacle and plugs,

FIG. 9B is an explanatory view illustrating an internal circuit of the output receptacle of the above combination output receptacle and plugs, and

FIG. 10 is a system configuration view illustrating a DC distribution system including the combination output receptacle and plugs in accordance with any embodiment.

### BEST MODE FOR CARRYING OUT THE INVENTION

### First Embodiment

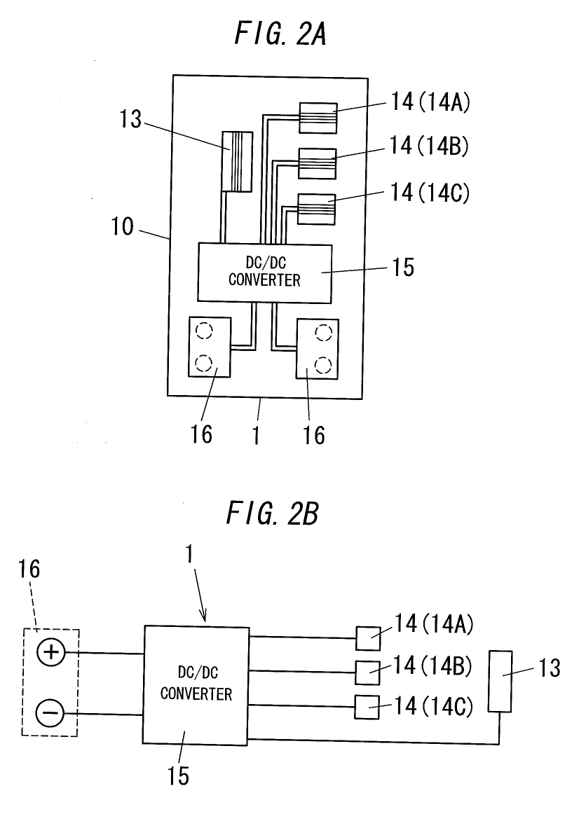

The output receptacle 1 of the present embodiment is a DC outlet and has a DC/DC converter 15 interposed between a terminal unit 16 and blade reception members 13 and 14 thereof, as shown in FIG. 2. The outlet 1 is configured to generate three different output voltages from a fixed input voltage applied to the terminal unit 16 by use of the DC/DC converter 15.

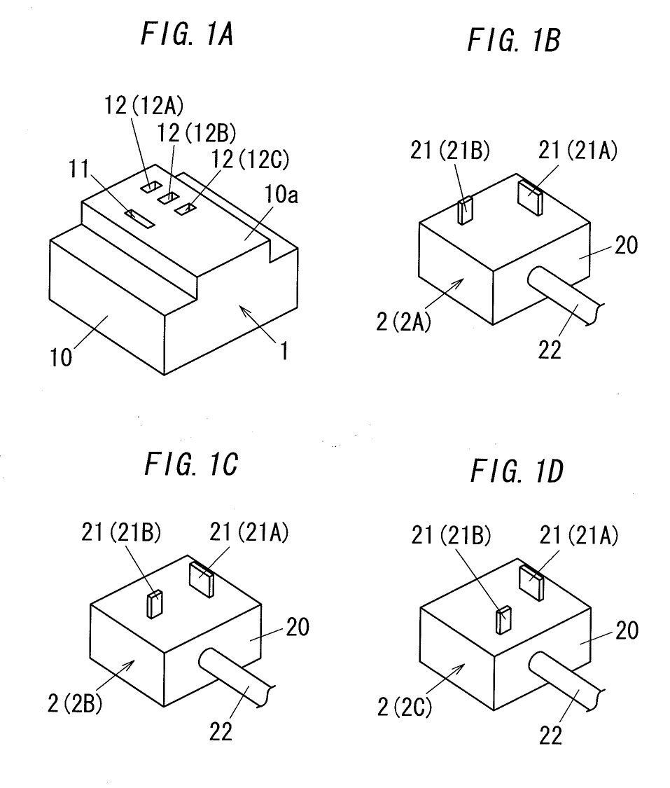

As shown in FIG. 1A, the outlet 1 is provided with a plurality of blade insertion slots 11 and 12 in its plug reception surface 10a. A blade reception member (hereinafter called “first blade reception member”, as necessary) 13 is located in the back of the blade insertion slot 11. Moreover, a blade reception member (hereinafter called “second blade reception member”, as necessary”) 14 is located in the back of each of the blade insertion slots 12. Each of the blade reception members 13 and 14 of the output receptacle 1 is shaped to have a narrow slot. The first blade reception member 13 is used in common and is supplied with a voltage of 0V. For example, three second blade reception members 14 are respectively supplied with the voltages of 12V, 24V, and 48V. The three second blade reception members 14 are arranged to be located differently from each other in accordance with its applied voltage, in view of the first blade reception member 13. The instance shown in FIG. 1 illustrates the first blade reception member 13 extending along its longitudinal direction. The three second blade reception members 14 are arranged beside the first blade reception member 13 and are juxtaposed along the longitudinal direction of the first blade reception member 13 at intervals.

The plug 2 is a socket plug for DC and includes two-pole blades 21 shaped into a rectangular plate shape. The plugs 2 have different shapes such that, while one blade 21 (21A) is connected to the first blade reception member 13, other blade 21 (21B) is connected to any one of the second reception members respectively adapted for 12V, 24V, and 48V of the output receptacle 1. That is, in the instance shown in FIG. 1, the one blade 21 (21A) of each plug 2 is arranged to be connected to the first blade reception member 13. However, the other blade 21 (21B) of the plug 2 for 12V has a shape capable of being connected to the second blade reception member 14 (14A) for 12V. The other blade 21 (21B) of the plug 2 for 24V has a shape capable of being connected to the second blade reception member 14 (14A) for 24V. The other blade 21 (21B) of the plug 2 for 48V has a shape capable of being connected to the second blade reception member 14 (14A) for 48V.

According to this embodiment, the three-pole second blade reception members 14 of the output receptacle 1 are arranged to be located differently from each other. Moreover, the other blades 21B of three plugs 2 are shaped differently from each other for connection respectively with the three-pole second blade reception members 14B. Therefore, it is possible to selectively connect plugs 2 for 12V, 24V, and 48V to the single output receptacle 1 without use of a conventional conversion adapter. Further, it is possible to prevent the other blade 21B of the plug 2 from being accidentally connected to the second blade reception member 14 of the different rated voltage. Therefore, it is possible to prevent an improper connection between the plug 2 and the output receptacle 1. Moreover, the combination output receptacle and plugs is capable of giving flexibility of being adapted to various DC supply voltages with increased versatility.

The following explains in detail the combination output receptacle and plugs of the present embodiment. The present embodiment includes the output receptacle 1 shown in FIG. 1 and the two-pole plug (insertion plug) 2. The combination output receptacle and plugs of the present embodiment provides different DC voltages (proper voltages) from the output receptacle 1 respectively to different plugs 2 selectively connected to the output receptacle 1.

The plug 2 includes a housing 20 shaped into a rectangular box shape. The pair of the blades 21 is projected from the first surface of the housing 20. The blade 21 is shaped into a rectangular plate shape and made of metals. In the following explanation, for the purpose of distinguishing the blades 21 in the pair, as necessary, the one blade 21 is called as “first blade” and is designated by the reference number of 21A, and the other blade 21 is called as “second blade” and is designated by the reference number of 21B.

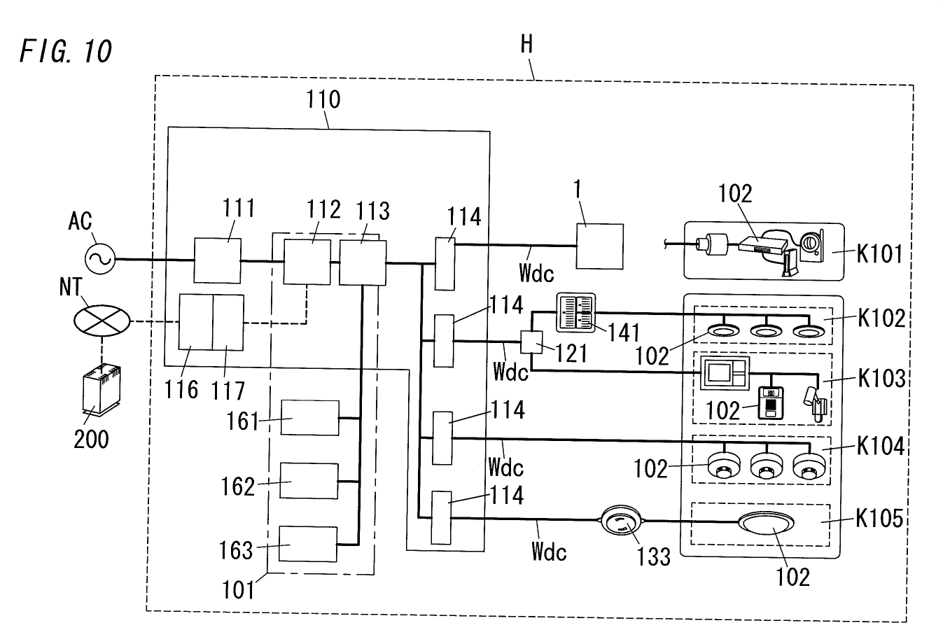

A cord 22 is led out from a different surface from the first surface of the housing 20. The cord 22 includes two insulating sheath cable (not shown) and one insulating tube surrounding the two insulating sheath cable. The one of the insulating sheath cable is connected to the first blade 21A in the inside of the housing 20. The other of the insulating sheath cable is connected to the second blade 21B in the inside of the housing 20. The cord 22 is directly or indirectly connected to a DC load such as a DC device 102 (see FIG. 10). Therefore, the DC device 102 is supplied with a voltage (DC voltage, in the present embodiment) applied between the first blade 21A and second blade 21B of the plug 2.

The output receptacle 1 includes an approximately rectangular box-shaped housing 10. The housing 10 is provided in its front surface (plug reception surface) 10a with a first blade insertion slot 11 designed to receive the first blade 21A of the plug 2. The housing 10 is, further, provided in its front surface with a plurality (three, in the present embodiment) of second blade insertion slots 12 respectively adapted to receive the second blade 21B of the plug 2. In the following explanation, for the purpose of distinguishing the three blade insertion slots 12, the three blade insertion slots 12 are respectively designated by the reference number of 12A, 12B, and 12C, as necessary.

The first blade insertion slot 11 is formed in a first width end of the front surface 10a of the housing 10. The first blade insertion slot 11 has a rectangular shape having its lateral direction parallel to the width direction of the housing 10. By contrast, the three second blade insertion slots 12A to 12C are formed in a second width end of the front surface 10a of the housing 10. Each of the second blade insertion slots 12 has a rectangular shape having its longitudinal direction parallel to the width direction of the housing 10. Further, in the front surface 10a of the housing 10, the three second blade insertion slots 12A to 12C are juxtaposed at predetermined intervals along a direction perpendicular to the width direction of the front surface 10a.

The housing 10 is provided in its rear surface with a cable insertion hole (not shown) adapted to be inserted a power cable of a DC power source (not shown) into.

As shown in FIGS. 2A and 2B, the housing 10 houses the first blade reception member 13 adapted to be connected to the first blade 21A and the second blade reception members 14 respectively adapted to be connected to the second blade 21B. Each of the blade reception members 13 and 14 is made of a metal plate. Such blade reception members 13 and 14 may be made to have an equivalent configuration of conventional blade reception member with necessary modification.

The first blade reception member 13 is housed in the housing 10 so as to be connected to the first blade 21A which is inserted into the housing 10 via the first blade insertion slot 11.

The three second blade reception members 14 are respectively corresponding to the three second blade insertion slots 12. In the following explanation, for the purpose of distinguishing the three blade reception members 14, the three blade reception members 14 are respectively designated by the reference number of 14A, 14B, and 14C, as necessary. In the present embodiment, the second blade reception member 14A is housed in the housing 10 so as to be connected to the second blade 21B which is inserted into the housing 10 via the second blade insertion slot 12A. The second blade reception member 14B is housed in the housing 10 so as to be connected to the second blade 21B which is inserted into the housing 10 via the second blade insertion slot 12B. The second blade reception member 14C is housed in the housing 10 so as to be connected to the second blade 21B which is inserted into the housing 10 via the second blade insertion slot 12C.

In the output receptacle 1 of the present embodiment, the blade insertion slots 11 and 12 provided to the housing 10 and the blade reception members 13 and 14 housed in the housing 10 constitute a plug connection unit adapted to be connected to the plug 2.

The housing 10, further, houses a DC/DC converter 15 and a terminal unit 16.

In the illustrated instance, the output receptacle 1 has the two terminal units 16. One of the terminal units 16 is connected to the power cable inserted into the housing 10 via the cable insertion hole. The other terminal unit 16 is used for a power transmission wiring.

The DC/DC converter 15 is configured to vary the DC voltage provided from the DC voltage source and to apply the resultant DC voltage between the first blade 21A and the second blade 21B. In the present embodiment, the DC/DC converter 15 is configured to apply different potentials respectively to the three second blade reception members 14A to 14C. For example, the DC/DC converter 15 applies 12V, 24V, and 48V to the second blade reception members 14A, 14B, and 14C, respectively. The DC/DC converter 15 is, further, configured to connect the first blade reception member 13 to a ground line of the power cable. In short, the DC/DC converter 15 applies 0V as a reference potential (ground potential) to the first blade reception member 13.

As described in the above, the output receptacle 1 of the present embodiment includes the plurality of the second blade reception members 14. The first blade reception member 13 is adapted to be supplied with the reference potential. The plurality of the second blade reception members 14A to 14C is adapted to be supplied with different potentials (12V, 24V, and 48V, in the present embodiment). Therefore, the output receptacle 1 of the present embodiment can provide the DC voltage selected from the three types of the DC voltages such as 12V, 24V, and 48V.

The output receptacle 1 permits a connection with the three types of the plugs 2 having the different rated voltages (proper voltages). In the following explanation, for the purpose of distinguishing the three types of the plugs 2 having the different rated voltages, the three plugs 2 are respectively designated by the reference number of 2A, 2B, and 2C as necessary.

As shown in FIGS. 1A to 1C, the plugs 2A to 2C are different from each other in a positional relation between the first blade 21A and the second blade 21B.

The plug 2A is provided to have the rated voltage of 12V (that is, a plug designed for 12V). Therefore, with regard to the plug 2A, the positional relation between the first blade 21A and the second blade 21B is determined such that the second blade 21B is connected to the second blade reception member 14A supplied with the voltage of 12V while the first blade 21A is connected to the first blade reception member 13. That is, the second blade 21B is equipped to the housing 20 to be connected to the second blade reception member 14A.

The plug 2B is provided to have the rated voltage of 24V (that is, a plug designed for 24V). Therefore, with regard to the plug 2B, the positional relation between the first blade 21A and the second blade 21B is determined such that the second blade 21B is connected to the second blade reception member 14B supplied with the voltage of 24V while the first blade 21A is connected to the first blade reception member 13. That is, the second blade 21B is attached to the housing 20 to be connected to the second blade reception member 14B.

The plug 2C is provided to have the rated voltage of 48V (that is, a plug designed for 48V). Therefore, with regard to the plug 2C, the positional relation between the first blade 21A and the second blade 21B is determined such that the second blade 21B is connected to the second blade reception member 14C supplied with the voltage of 48V while the first blade 21A is connected to the first blade reception member 13. In short, the second blade 21B is secured to the housing 20 to be connected to the second blade reception member 14C.

Thus, the second blade 21B of the plug 2 is configured to be connected to any one of the plurality of the second blade reception members 14 in accordance with the rated voltage of the plug 2.

As described in the above, according to the combination outlet receptacle and plugs of the present embodiment, when the plug 2 is connected to the output receptacle 1, the second blade 21B is connected to any one of the plurality of the second blade reception members 14A to 14C in accordance with the rated voltage of the plug 2 while the first blade 21A is connected to the first blade reception member 13. Herein, the first blade reception member 13 is adapted to be supplied with the reference potential (0V) and the plurality of the second blade reception members 14A to 14C is adapted to be supplied with different potentials (12V, 24V, and 48V). Therefore, applied between the first blade 21A and the second blade 21B of the plug 2 is a voltage according to the rated voltage of the plug 2. Accordingly, it is possible to selectively connect plugs 2A to 2C having different rated voltages to the single output receptacle 1 without use of a conversion adapter (a user can select and use the desired plug 2). Thus, the combination output receptacle and plugs is capable of giving flexibility of being adapted to various DC supply voltages with increased versatility. Further, the positional relations between the first blade 21A and second blade 21B are different from each other, and each of the positional relations between the first blade 21A and second blade 21B is defined in accordance with the rated voltage of the plug 2. Accordingly, for example, when a user connects the plug 2A to the output receptacle 1, the second blade 21B is prevented from being connected to not the second blade reception member 14A but any one of the second blade reception members 14B and 14C. Therefore, it is possible to successfully prevent the occurrence of the improper connection.

In the present embodiment, the three types of voltages such as 12V, 24V, and 48V are exemplified as the rated voltages of the plugs 2. However, the rated voltage of the plug 2 is not limited to the aforementioned three voltages and can be selected from other voltages. That is, configurations (such as the output voltage and the pole number) of the combination output receptacle and plugs can be modified in as necessitated in a particular application of the combination output receptacle and plugs. This applies also to the second embodiment discussed later.

In the combination outlet receptacle and plugs of the present embodiment, the second blade reception members 14 may be arranged to be shaped or located differently from each other. Each of the second blade reception members 14 may be shaped or located in conformity with the potential applied thereto. Further, the second blades 21B of the plurality of the plugs 2 may be shaped or located differently from each other for connection respectively to the second blade reception members 14. Each of the second blades 21B may be shaped or located in accordance with the corresponding second blade reception member 14.

### Second Embodiment

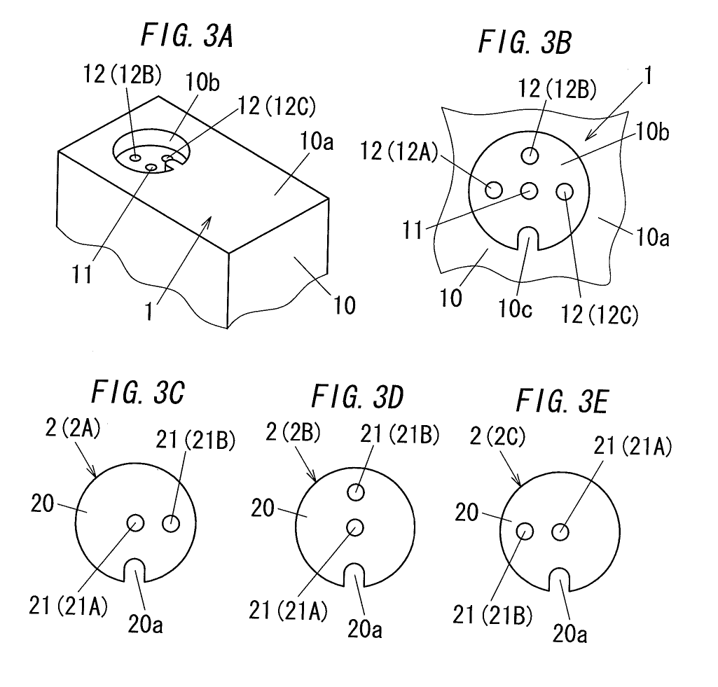

FIG. 3 shows an instance where the blade reception members 13 and 14 of the output receptacle 1 have a pinhole shape as well as the blades 21 of the plug 2 have a pin shape. The other components of the combination output receptacle and plugs are same as those of the embodiment illustrated in FIGS. 1 and 2. In the present instance, the first blade reception member 13 is disposed at the center of the front surface 10a of the housing 10. For example, the three types of the second blade reception members 14 (14A, 14B, and 14C) respectively designed for 12V, 24V, and 48V are arranged on a circle centered on the first blade reception member 13 and spaced from each other by an angle of 90°. Meanwhile, the plug 2 includes the pin-shaped two-pole blades 21. The first blade 21A has a shape corresponding to the first blade reception member 13 of the output receptacle 1. The second blade 21B has a shape corresponding to any one of the three-pole second blade reception members 14 of the output receptacle 1. In short, the single plug 2 includes any one of the second blades 21B respectively corresponding to the second blade reception members 14A, 14B, and 14C of the output receptacle 1. Like the first embodiment, it is possible to selectively connect the three types of the plugs 2 (e.g. the plug 2 for 12V, the plug 2 for 24V, and the plug 2 for 48V) to the single output receptacle 1.

The following explains in detail the combination output receptacle and plugs of the present embodiment. The present embodiment includes the output receptacle 1 shown in FIG. 1 and the two-pole plug (insertion plug) 2. The combination output receptacle and plugs of the present embodiment provides different DC voltages (proper voltages) from the output receptacle 1 respectively to different plugs 2 selectively connected to the output receptacle 1. The components same as the first embodiment are designated by like reference numerals and dispensed with duplicate explanations.

The housing 20 of the plug 2 of the present embodiment has its outer periphery shaped into a circular shape. Projected from the front surface of the housing 20 are the first blade 21A and the second blade 21B. Each of the blades 21A and 21B is shaped into a round bar shape. That is, the blade 21 of the plug 2 has the pin shape. The cord 22 is led out from the rear surface of the housing 20. However, this is not shown in FIG. 3. A cutout 20a is provided in the front end of the outer periphery of the housing 20 and used for positioning the plug 2 in relation to the output receptacle 1.

In the output receptacle 1 of the present embodiment, the housing 10 is provided with a recess 10b in its front surface 10a. The recess 10b has its inner periphery slightly larger than the outer periphery of the housing 20 of the plug 2. The first blade insertion slot 11 and the second blade insertion slots 12 are formed in the bottom of the recess 10b. The blade insertion slots 11 and 12 have a circular shape. That is, the blade insertion slots 11 and 12 of the output receptacle 1 have the pinhole shape. The housing 10 is provided with a protrusion 10c on the inner periphery of the recess lob. The protrusion 10c is shaped to fit into the cutout 20a.

In the output receptacle 1, the first blade insertion slot 11 is formed at the center of the bottom of the recess lob. The second blade insertion slot 12A is formed in a first width end (left end, in FIG. 3A) of the bottom of the recess 10b. The second blade insertion slot 12B is formed in an opposite side of the protrusion 10c from the first blade insertion slot 11. The second blade insertion slot 12C is formed in a second width end (right end, in FIG. 3A) of the bottom of the recess 10b. In the illustrated instance, the second blade insertion slots 12 are arranged on a circle centered on the first blade insertion slot 11 and angularly spaced from each other by 90°

Like the first embodiment, the housing 10 of the output receptacle 1 houses the first blade reception member 13, the second blade reception members 14A to 14C, the DC/DC converter 15, and the terminal units 16. The first blade reception member 13 and the second blade reception member 14 are shaped to connect to the pin-shaped blade 21. The blade reception members 13 and 14 may be of known configuration and therefore no detailed explanation thereof is deemed necessary. The DC/DC converter 15 and the terminal unit 16 are the same as those of the first embodiment, and therefore no detailed explanations thereof are deemed necessary.

The plug 2A shown in FIG. 3C has the rated voltage of 12V. Therefore, with regard to the plug 2A, the positional relation between the first blade 21A and the second blade 21B is determined such that the second blade 21B is connected to the second blade reception member 14A supplied with the voltage of 12V while the first blade 21A is connected to the first blade reception member 13. The plug 2B shown in FIG. 3D has the rated voltage of 24V. Therefore, with regard to the plug 2B, the positional relation between the first blade 21A and the second blade 21B is determined such that the second blade 21B is connected to the second blade reception member 14B supplied with the voltage of 24V while the first blade 21A is connected to the first blade reception member 13. The plug 2C shown in FIG. 3E has the rated voltage of 48V. Therefore, with regard to the plug 2C, the positional relation between the first blade 21A and the second blade 21B is determined such that the second blade 21B is connected to the second blade reception member 14C supplied with the voltage of 48V while the first blade 21A is connected to the first blade reception member 13. Thus, the second blade 21B of the plug 2 illustrated in respective FIGS. 3C to 3E is configured to be connected to any one of the plurality of the second blade reception members 14 in accordance with the rated voltage of the plug 2.

Therefore, like the first embodiment, the combination output receptacle and plugs is capable of selectively connecting the plugs 2A to 2C having different rated voltages to the single output receptacle 1 without use of a conversion adapter. Thus, the combination output receptacle and plugs is capable of giving flexibility of being adapted to various DC supply voltages with increased versatility. Further, the positional relations between the first blade 21A and second blade 21B are different from each other, and each of the positional relations between the first blade 21A and second blade 21B is defined in accordance with the rated voltage of the plug 2. Therefore, it is possible to successfully prevent the occurrence of the improper connection.

### Third Embodiment

The combination output receptacle and plugs of the present embodiment is configured to provide different DC voltages from the output receptacle 1 respectively to the different plugs 2 selectively connected to the output receptacle 1. Each of the plugs 2 is provided with the two-pole blades 21 adapted to be connected respectively to the two-pole blade reception members 13 and 14 of the output receptacle 1. The output receptacle 1 is provided with a voltage switch 17 configured to select one of the different DC voltages being supplied across the two-pole blade reception members 13 and 14 when the blades 21 of the plug 2 are respectively connected to the blade reception members 13 and 14 of the output receptacle 1. The plugs 2 are provided respectively with projections 23 which come into contact with the voltage switch 17 when the blades 21 are respectively connected to the blade reception members 13 and 14 of the output receptacle 1. The projections 23 of the plugs 2 are shaped or located differently from each other. The voltage switch 17 is configured to select a proper one from the different DC voltage depending on the shape or location of the projection 23 of the plug 2 in contact with the voltage switch 17. In the present embodiment, the output receptacle 1 includes a plurality (two, in the present embodiment) of the voltage switches 17 located in differently from each other depending on the DC voltage to be switched. The protrusion 23 is shaped or located to be contacted to either one of the two voltage switches 17 corresponding to the proper DC voltage.

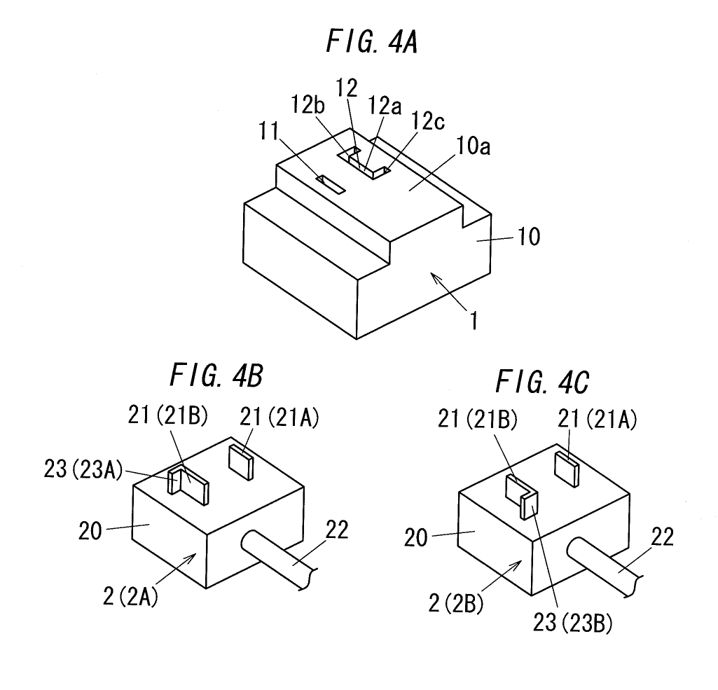

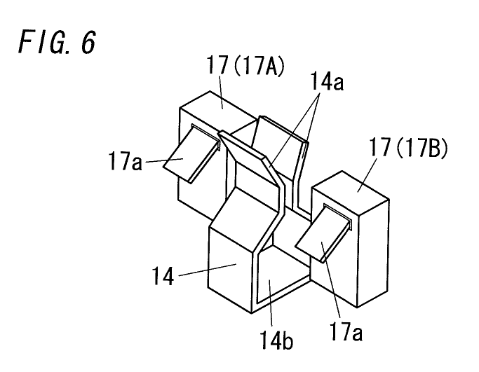

In the present embodiment, as shown in FIG. 4A, the output receptacle 1 includes the I-shaped first blade insertion slot 11 and the U-shaped second blade insertion slot 12. The second blade insertion slot 12 includes a longitudinal slot 12a and a pair of L-shaped bend slots 12b and 12c continuously extending from the opposite ends of the longitudinal slot 12a. The first blade reception member 13 is located in the back of the blade insertion slot 11. As shown in FIG. 6, the second blade reception member 14 is located in the back of the longitudinal slot 12a, and the pair of the voltage switches 17 is respectively located in the back of the pair of the bend slots 12b and 12c. There are operation pieces (switching unit) 17a extending respectively to the bend slots 12b and 12c from left and right switch boxes. For example, one of the voltage switches 17 (17A) is designed for selecting the voltage of 24V, and another of the voltage switches 17 (17B) is designed for selecting the voltage of 48V.

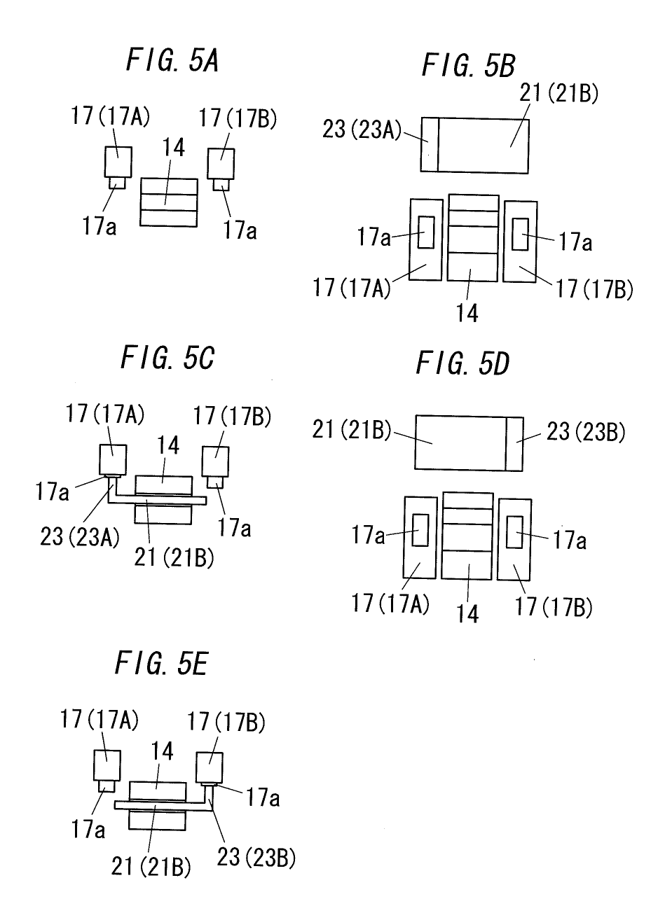

As shown in FIGS. 4B and 4C, the first blade 21A of the plug 2 is shaped to be inserted into the first blade insertion slot 11 and to be connected to the first blade reception member 13. The second blade 21B is shaped to be inserted into the second blade insertion slot 12 and to be connected to the second blade reception member 14. The protrusions 23 are respectively formed on opposite ends of the second blade 21B. The protrusion 23 is shaped to press either the operation piece 17a of the voltage switch 17A for the voltage of 24V or the operation piece 17a of the voltage switch 17B for the voltage of 48V. Especially, as shown in FIG. 5C, the protrusion 23 of the plug 2 for 24V is shaped and dimensioned to extend through the bend slot 12b for pressing the operation piece 17a of the voltage switch 17 for 24V when the second blade 21B is connected to the second blade reception member 14 (see FIG. 4A). As shown in FIG. 5E, the protrusion 23 of the plug 2 for 48V is shaped and dimensioned to extend through the bend slot 12c for pressing the operation piece 17a of the voltage switch 17 for 48V when the second blade 21B is connected to the second blade reception member 14 (see FIG. 4A).

In the above explained present embodiment, when the first blade 21A and the second blade 21B of the plug 2 are connected to the first blade reception member 13 and the second blade reception member 14 of the output receptacle 1 respectively, the protrusion 23 integrally formed on the second blade 21B presses the voltage switch 17 such that the combination output receptacle and plugs provide the voltage corresponding to the rated voltage of the plug 2. Therefore, it is possible to selectively connect one or more plugs 2 having different rated voltages to the single output receptacle 1. Thus, the combination output receptacle and plugs is capable of giving flexibility of being adapted to various DC supply voltages with increased versatility. In addition, it is possible to select and output the proper voltage corresponding to the specification of the plug 2 by employing a simple configuration where the plug 2 is provided with the projection 23. Therefore, a complex switch mechanism and manipulating means is unnecessary, and usability is improved.

The following explains in detail the combination output receptacle and plugs of the present embodiment. The present embodiment includes the output receptacle 1 shown in FIG. 4 and the two-pole plug (insertion plug) 2. The combination output receptacle and plugs of the present embodiment provides different DC voltages (proper voltages) from the output receptacle 1 respectively to the different plugs 2 selectively connected to the output receptacle 1. The components same as the first embodiment are designated by like reference numerals and dispensed with duplicate explanations.

The plug 2 of the present embodiment includes the housing 20, the first blade 21A, and the second blade 21B, in the same manner as that of the first embodiment. Like the first embodiment, the cord 22 is connected to the plug 2. Herein, the plug 2 of the present embodiment is provided with the protrusion 23. The protrusion 23 is shaped into a rectangular plate shape and integrally formed on the second blade 21B. In the plug 2 of the present embodiment, the first blade 21A and second blade 21B are arranged in parallel to each other.

With regard to the second blade 21B, the location of the protrusion 23 depends on the rated voltage of the plug 2. The plug 2A shown in FIG. 2B has the rated voltage of 24V and the plug 2B shown in FIG. 2C has the rated voltage of 48V. With regard to the plug 2A, the protrusion 23 is projected from the first width end of the second blade 21B. The protrusion 23 is projected to an opposite side of the second blade 21B from the first blade 21A. By contrast, with regard to the plug 2B, the protrusion 23 is projected from the second width end of the second blade 21B. The protrusion 23 is projected to an opposite side of the second blade 21B from the first blade 21A. In the following explanation, as necessary, the protrusion 23 of the plug 2A is designated with a suffix letter of “A”, and the protrusion 23 of the plug 2B is designated with a suffix letter of “B”.

The output receptacle 1 of the present embodiment includes the housing 10 in the same manner as that of the first embodiment. As shown in FIG. 4A, the housing 10 is provided in its front surface (plug insertion surface) 10a with the first blade insertion slot 11 adapted to receive the first blade 21A of the plug 2. Further, the housing 10 is provided in its front surface 10a with the second blade insertion slot 12 adapted to receive the second blade 21B of the plug 2.

The first blade insertion slot 11 is formed in the first width end of the front surface 10a of the housing 10. The first blade insertion slot 11 has a rectangular shape having its lateral direction parallel to the width direction of the housing 10. By contrast, the three second blade insertion slot 12 is formed in the second width end of the front surface 10a of the housing 10. The second blade insertion slot 12 is shaped to have the first insertion slot (longitudinal slot) 12a, the second insertion slot (bend slot) 12b, and the third insertion slot (bend slot) 12c which are communicated to each other. The first insertion slot 12a is adapted to be inserted the second blade 21A into. The second insertion slot 12b is adapted to be inserted the protrusion 23A into. The third insertion slot 12c is adapted to be inserted the protrusion 23B into. The first insertion slot 12a has a rectangular shape having its longitudinal direction parallel to the width direction of the housing 10.

The housing 10 is provided with the cable insertion hole in its rear surface, in the same manner as that of the first embodiment.

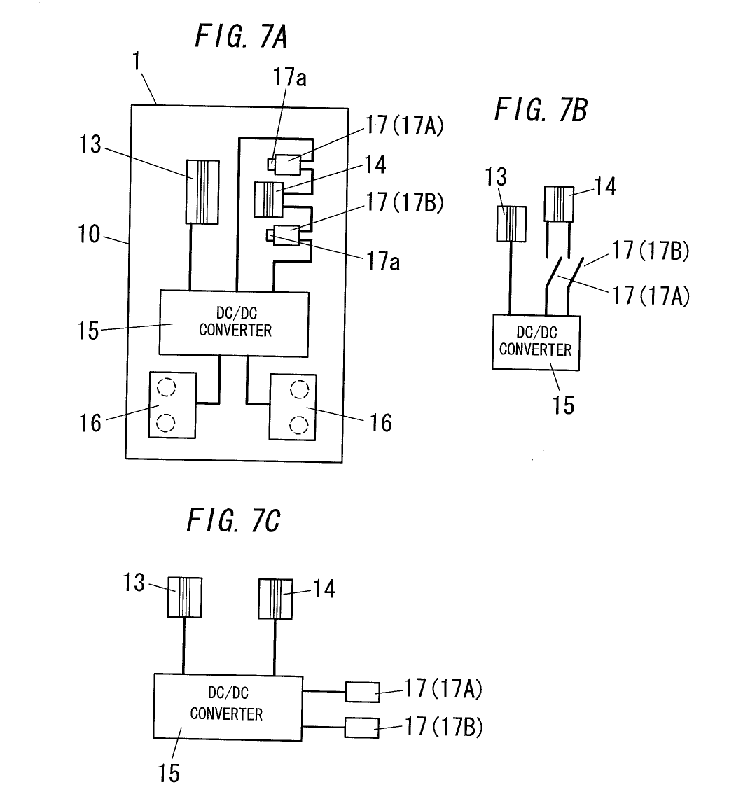

As shown in FIG. 7A, the housing 10 houses the blade reception member (hereinafter called “first blade reception member”, as necessary) 13 adapted to be connected to the first blade 21A and the blade reception member (hereinafter called “second blade reception member”, as necessary) 14 adapted to be connected to the second blade 21B.

As shown in FIG. 6, the second blade reception member 14 includes a pair of blade reception springs 14a and a connection piece 14b integrally connecting base ends of the blade reception springs 14a of the pair. The pair of the blade reception springs 14a is provided to catch the second blade 21B between the blade reception springs 14a. The first blade reception member 13 is shaped into the same shape as the second blade reception member 14. Each of the blade reception members 13 and 14 is made of a metal plate. Such blade reception members 13 and 14 may be made to have an equivalent configuration of conventional blade reception member with necessary modification. In the output receptacle 1 of the present embodiment, the blade insertion slots 11 and 12 provided to the housing 10 and the blade reception members 13 and 14 housed in the housing 10 constitute the plug connection unit adapted to be connected to the plug 2.

The housing 10, further, houses the plurality (two, in the present embodiment) of the voltage switches 17 in addition to the DC/DC converter 15 and the terminal unit 16. The terminal unit 16 is the same as that of the first embodiment, and therefore no detailed explanation is deemed necessary.

The DC/DC converter 15 is configured to vary the DC voltage provided from the DC voltage source and to apply the resultant DC voltage between the first blade 21A and the second blade 21B. In the present embodiment, the DC/DC converter 15 is configured to select a potential applied to the second blade reception member 14 from different potentials. For example, the DC/DC converter 15 includes a first output terminal (not shown) for applying the potential of 24V to the second blade reception member 14 and a second output terminal (not shown) for applying the potential of 48V to the second blade reception member 14. The DC/DC converter 15 is, further, configured to connect the first blade reception member 13 to the ground line of the power cable. In short, the DC/DC converter 15 applies 0V as the reference potential (ground potential) to the first blade reception member 13.

The voltage switch 17 includes the switching unit (operation piece) 17a configured to turn on and off contacts. The voltage switch 17 is configured to keep turning on while the operation piece 17a is pressed. That is, the voltage switch 17 is of normally open type. In the following explanation, for the purpose of distinguishing the two voltage switches 17, the two voltage switches 17 are respectively designated by the reference numbers of 17A and 17B, as necessary.

As shown in FIGS. 6A and 6B, each of the voltage switches 17 is provided to a power line between the DC/DC converter 15 and the second blade reception member 14. In more detail, as shown in FIGS. 6A and 6B, the voltage switch 17A is provided to the power line between the first output terminal of the DC/DC converter 15 and the second blade reception member 14. The voltage switch 17A is positioned to locate its operation piece 17a outwardly of the second insertion slot 12b of the second blade insertion slot 12 so as to be accessible from outside of the housing 10. Thereby, the operation piece 17a is pressed by the protrusion 23A inserted into the second insertion slot 12b. In the present embodiment, in the case of the second blade 21B being connected to the second blade reception member 14, the voltage switch 17A is turned on because a pressing amount of the operation piece 17a of the voltage switch 17A exceeds a predetermined amount.

The voltage switch 17B is provided to the power line between the second output terminal of the DC/DC converter 15 and the second blade reception member 14. The voltage switch 17B is positioned to locate its operation piece 17a outwardly of the second insertion slot 12c of the second blade insertion slot 12 so as to be accessible from outside of the housing 10. Thereby, the operation piece 17a is pressed by the protrusion 23B inserted into the third insertion slot 12c. In the present embodiment, in the case of the second blade 21B being connected to the second blade reception member 14, the voltage switch 17B is turned on when a pressing amount of the operation piece 17a of the voltage switch 17B exceeds a predetermined amount.

The operation piece 17a of each of the voltage switches 17 is inclined to have its free end located closer to the back of the housing 10 than its fixed end. Accordingly, the protrusion 23 can easily press the operation piece 17a.

The output receptacle 1 is constructed as described in the above. Next, an explanation is made to an operation of the output receptacle 1 when the plug 2 is connected thereto, with reference to FIG. 5.

As shown in FIG. 5A, the operation pieces 17a of both the voltage switches 17 are not pressed until the plug 2 is connected to the output receptacle 1. Therefore, both the voltage switches 17 are kept turned off. Thus, the DC/DC converter 15 applies no potential to the second blade reception member 14.

As shown in FIGS. 5B and 5C, the protrusion 23A presses the operation piece 17a of the voltage switch 17A when the plug 2A shown in FIG. 4B is connected to the output receptacle 1. Thus, only the voltage switch 17A is turned on. In this case, the DC/DC converter 15 has the first output terminal alone connected to the second blade reception member 14. Therefore, the second blade reception member 14 is supplied with the potential of 24V. As a result, the voltage of 24V is applied between the blade reception members 13 and 14 in the pair. Accordingly, the plug 2A is supplied with the DC voltage corresponding to its rated voltage.

By contrast, as shown in FIGS. 5D and 5E, the protrusion 23B presses the operation piece 17a of the voltage switch 17B when the plug 2B shown in FIG. 4C is connected to the output receptacle 1. Thus, only the voltage switch 17B is turned on. In this case, the DC/DC converter 15 has the second output terminal alone connected to the second blade reception member 14. Therefore, the second blade reception member 14 is supplied with the potential of 48V. As a result, the voltage of 48V is applied between the blade reception members 13 and 14 in the pair. Accordingly, the plug 2B is supplied with the DC voltage corresponding to its rated voltage.

As described in the above, in the present embodiment, the voltage across the blade reception members becomes 24V when the voltage switch 17A is turned on and the voltage switch 17B is turned off. The voltage across the blade reception members becomes 48V when the voltage switch 17A is turned off and the voltage switch 17B is turned on. That is, in the output receptacle 1 of the present embodiment, the voltage switches 17A and 17B constitute a voltage selection unit configured to select the DC voltage applied between the blade reception members 13 and 14 in the pair. When the plug 2 is connected to the output receptacle 1, the protrusion 23 functions to select a voltage designated by the rated voltage of the plug 2 in cooperation with the voltage switches 17A and 17B of the voltage selection unit.

As described in the above, the output receptacle 1 of the present embodiment includes the voltage selection unit and is configured to apply the DC voltage selected by the voltage selection unit between the blade reception members 13 and 14 in the pair. The plug 2 of the present embodiment includes the protrusion 23 as an operation unit configured to operate the voltage selection unit to select a voltage according to the rated voltage of the plug 2 when the plug 2 is connected to the output receptacle 1.

According to the combination output receptacle and plugs of the present embodiment, the protrusion 23 selects the DC voltage in accordance with the rated voltage of the plug 2 when the plug 2 is connected to the output receptacle 1. Therefore, applied between the blades 21A and 21B of the pair of the plug 2 is the voltage according to the rated voltage of the plug 2. Accordingly, it is possible to selectively connect plugs 2 having different rated voltages to the single output receptacle 1 without use of a conversion adapter. Thus, the combination output receptacle and plugs is capable of giving flexibility of being adapted to various DC supply voltages with increased versatility. Further, the number of the blade reception members 13 and 14 need not be increased because the output receptacle 1 varies the voltage applied between the blade reception members 13 and 14 in the pair.

In particular, according to the present embodiment, the voltage selection unit includes the plurality (two, in the present embodiment) of voltage switches 17 and is configured to select the DC voltage in accordance with on/off states of each of the voltage switches 17. Further, the protrusion 23 is configured to switch the on/off states of the voltage switches 17 when the plug 2 is connected to the output receptacle 1.

Accordingly, it is possible to select the DC voltage of the output receptacle 1 in accordance with the rated voltage of the plug 2 by employing a simple configuration where the plug 2 is provided with the projections. Therefore, a complex switch mechanism and manipulating means is unnecessary, and usability is improved. Further, the DC voltage can be varied in line with the rated voltage of the plug 2 by simple arrangement of the voltage switches 17 of the voltage selection unit and/or the protrusion 23.

In the present output receptacle 1, the voltage switch 17 is provided to the power line between the DC/DC converter 15 and the second blade reception member 14 (see FIG. 7B). However, as shown in FIG. 7C, the DC/DC converter 15 may be directly connected to the second blade reception member 14. In this case, the DC/DC converter 15 is configured to select the potential applied to the second blade reception member 14 in accordance with the on/off states of each of the voltage switches 17A and 17B. In particular, the DC/DC converter 15 is configured to apply the potential of 24V to the second blade reception member 14 while the voltage switch 17A is turned on and the voltage switch 17B is turned off, and to apply the potential of 48V to the second blade reception member 14 while the voltage switch 17A is turned off and the voltage switch 17B is turned on. The output receptacle 1 of this modification also can vary the DC voltage across blade reception members 13 and 14 in accordance with the rated voltage of the plug 2.

As described in the above, in the combination output receptacle and plugs of the present embodiment, it is sufficient that the output receptacle 1 is provided with the voltage switch 17 configured to select one of the different DC voltages being supplied across the blade reception members 13 and 14 in the pair, and that the plugs 2 are provided respectively with projections 23 which come into contact with the voltage switch 17 when the blades 21 are connected to the blade reception members 13 and 14. Herein, it is sufficient that the projections 23 of the plugs 2 are shaped or located differently from each other, and that the output receptacle 1 is configured to select a proper one from the different DC voltage depending on the shape or location of the projection 23 of the plug 2 in contact with the voltage switch 17. Further, it is sufficient that the combination output receptacle and plugs includes a plurality of the voltage switches 17 located in differently from each other depending on a DC voltage to be switched. It is sufficient that the protrusion 23 is shaped or located to be contacted to the voltage switch 17 corresponding to the proper DC voltage when the blades 21 of the plug 2 are respectively connected to the blade reception members 13 and 14 of the output receptacle 1.

### Fourth Embodiment

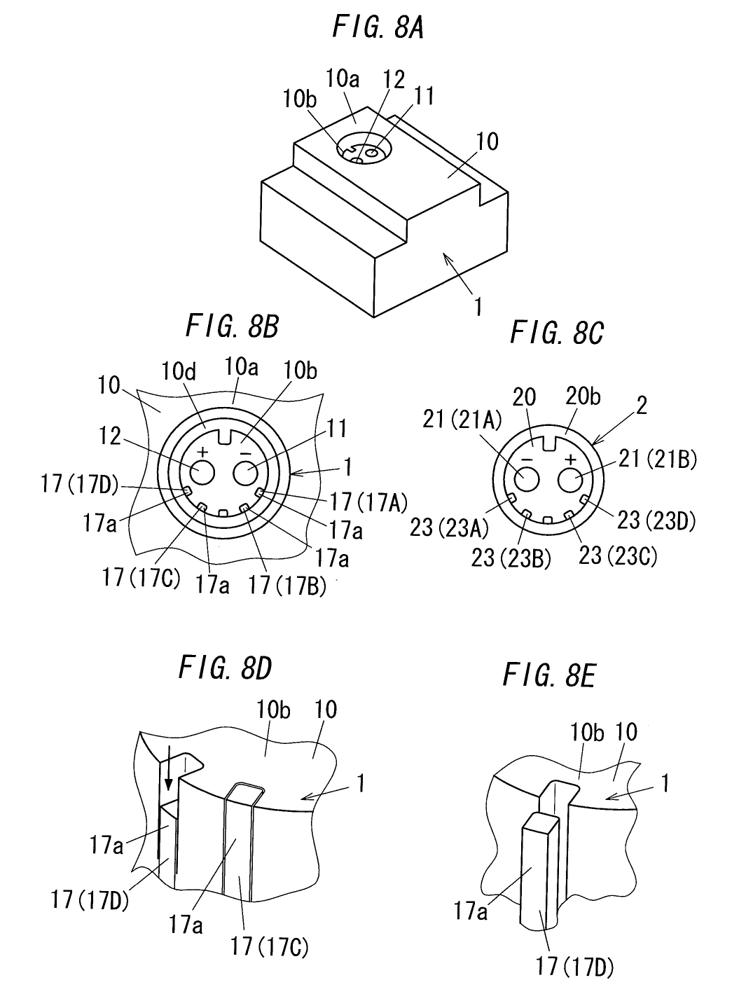

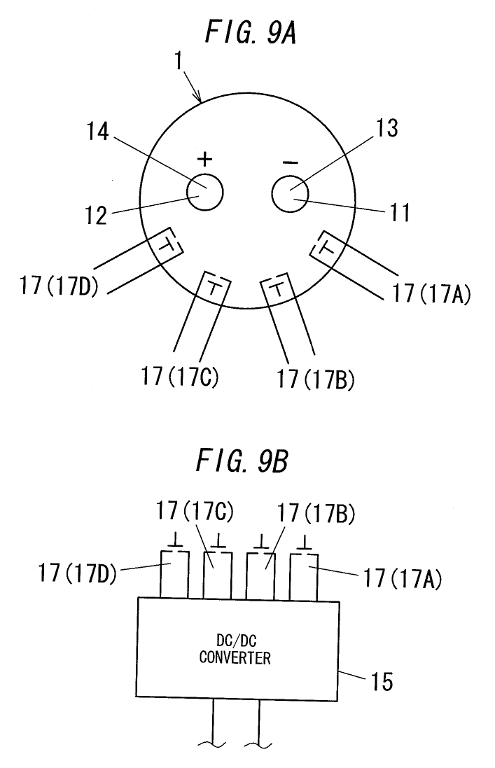

The third embodiment exemplifies the switching of the two voltages (24V and 48V). However, as shown in FIGS. 8 and 9, it is also possible to add the number of the voltage switches 17 for realizing a selection of a voltage from four different voltage levels, for example, 6V, 12V, 24V, and 48V. FIG. 8 exemplifies the pin-shaped blade 21 and the pinhole-shaped blade reception members 13 and 14. As shown in FIGS. 8A, 8B, and 9, the first blade reception member 13 and the second blade reception member 14 are provided to the center side of the output receptacle 1. The four operation pieces 17a are arranged outwardly of the output receptacle 1 and circumferentially spaced apart by an angle of 30°. The voltage switch 17 of the present instance is switched when the operation piece 17a is pressed downwardly. Thus, supplied to the plug 2 is a voltage corresponding to the switched voltage switch 17. As shown in FIG. 8C, plug 2 is provided with the pair of the blades 21, and the single protrusion 23 to come into contact with any one of the four operation pieces 17a of the output receptacle 1. For example, the plug 2 shown in FIG. 8 is provided with the protrusion 23 (23D) only at a position corresponding to the voltage switch 17D for 48V, and is devoid of such protrusion 23 at remain three positions respectively corresponding to the voltage switches 17A, 17B, and 17C. When the plug 2 designed for 48V is connected to the output receptacle 1, the protrusion 7 presses the operation piece 17a corresponding to 48V as shown in FIG. 8D. Thereby, the voltage of 48V is selected. The operation piece 17a needs not to be configured to function when being pressed downwardly. For example, as shown in FIG. 8E, the voltage switch 17 can be configured to be switched when the protrusion 23 shifts the operation piece 17a laterally. According to the configuration, it is possible to selectively connect the four types of the plugs 2 to the single output receptacle 1. Although the present instance exemplifies the combination output receptacle and plugs employing the voltage switches 17 in order to provide the four types of the voltages, the combination output receptacle and plugs is not limited to the aforementioned instance. The number of the voltage switches 17 can be selected in accordance with the necessitated voltage level.

The following explains in detail the combination output receptacle and plugs of the present embodiment. The present embodiment includes the output receptacle 1 shown in FIGS. 8 and 9, and the two-pole plug 2. The combination output receptacle and plugs of the present embodiment provides different DC voltages (proper voltages) from the output receptacle 1 respectively to the different plugs 2 selectively connected to the output receptacle 1. The components same as the third embodiment are designated by like reference numerals and dispensed with duplicate explanations.

The housing 20 of the plug 2 in accordance with the present embodiment has its outer periphery shaped into a circular shape. Projected from the front surface of the housing 20 are the first blade 21A and the second blade 21B. Each of the blades 21A and 21B is shaped into a round bar shape. That is, the blade 21 of the plug 2 has the pin shape. The cord 22 is led out from the rear surface of the housing 20. However, this is not shown in FIG. 8C. The housing 20 is provided on its front surface with a peripheral wall 20b extending from its outer periphery. The peripheral wall 20b is used for positioning the plug 2 in relation to the output receptacle 1.

The plug 2 of the present embodiment also includes the protrusion 23. The protrusion 23 has a square bar shape extending along the forward/rearward direction of the housing 20 and is provided to an inner periphery of the peripheral wall 20b. Although FIG. 8C illustrates the four protrusions 23, the plug 2 is actually provided with the single protrusion 23. In the following explanation, for the purpose of distinguishing the four protrusions 23, the four protrusions 23 are designated by the reference numbers of 23A to 23D respectively, as necessary.

In the output receptacle 1 of the present embodiment, the housing 10 is provided with the recess 10b in its front surface 10a. The recess 10b has its inner periphery slightly larger than the outer periphery of the housing 20 of the plug 2. As shown in FIG. 8B, the first blade insertion slot 11 and the second blade insertion slots 12 are formed in the bottom of the recess 10b. The blade insertion slots 11 and 12 have a circular shape. That is, the blade insertion slots 11 and 12 of the output receptacle 1 have the pinhole shape. The housing 10 is provided with a circular-shaped groove 10d in the bottom of the recess 10b. The groove 10d is shaped to receive the peripheral wall 20b of the plug 2.

In the output receptacle 1, the first blade insertion slot 11 is formed at the center of the bottom of the recess 10b. The second blade insertion slot 12A is formed in a first width end (left end, in FIG. 3A) of the bottom of the recess 10b. The second blade insertion slot 12B is formed in an opposite side of the protrusion 10c from the first blade insertion slot 11. The second blade insertion slot 12C is formed in a second width end (right end, in FIG. 3A) of the bottom of the recess 10b.

Like the third embodiment, the housing 10 of the output receptacle 1 houses the first blade reception member 13, the second blade reception member 14, the DC/DC converter 15, the terminal unit 16, and the plurality (four, in the present embodiment) of the voltage switches 17. The first blade reception member 13 and the second blade reception member 14 are shaped to connect to the pin-shaped blade 21. The blade reception members 13 and 14 may be of known configuration and therefore no detailed explanation thereof is deemed necessary. The terminal unit 16 and the voltage switches 17 are the same as those of the third embodiment, and therefore no detailed explanations thereof are deemed necessary. In the following explanation, for the purpose of distinguishing the four voltage switches 17, the four voltage switches 17 are designated by the reference numbers of 17A to 17D respectively, as necessary.

The DC/DC converter 15 of the present embodiment is directly connected to the second blade reception member 14. As shown in FIG. 9B, the DC/DC converter 15 is configured to select the potential applied to the second blade reception member 14 in accordance with the on/off states of each of the voltage switches 17A, 17B, 17C, and 17D. In particular, the DC/DC converter 15 is configured to provide the potential of 6V to the second blade reception member 14 while only the voltage switch 17A is turned on. The DC/DC converter 15 is configured to provide the potential of 12V to the second blade reception member 14 while only the voltage switch 17B is turned on. The DC/DC converter 15 is configured to provide the potential of 24V to the second blade reception member 14 while only the voltage switch 17C is turned on. The DC/DC converter 15 is configured to provide the potential of 48V to the second blade reception member 14 while only the voltage switch 17D is turned on. The DC/DC converter 15 is configured to apply no voltage between the blade reception members 13 and 14 in the pair while each of the voltage switches 17 is turned off. Like the third embodiment, the DC/DC converter 15 is configured to provide the potential of 0V to the first blade reception member 13.

That is, the DC/DC converter 15 is configured to select the DC voltage across the blade reception members 13 and 14 in the pair in accordance with the on/off states of each of the voltage switches 17A, 17B, 17C, and 17D. In the present embodiment, the DC voltage can be selected from the four voltages such as 6V, 12V, 24V, and 48V.

As shown in FIGS. 8B and 9A, the operation pieces 17a of each of the voltage switches 17A to 17D are exposed on the bottom of the recess 10b of the housing 10. The operation pieces 17a are circumferentially spaced apart by an angle of 30°. The protrusion 23A is provided to the housing 20 of the plug 2 to press the operation piece 17a of the voltage switch 17A when the plug 2 is connected to the output receptacle 1. Likewise, the protrusion 23B, 23C, and 23D are provided to the housing 20 of the plug 2 to press the operation piece 17a of the voltage switches 17B, 17C, and 17D respectively. Therefore, the plug 2 (designated by the reference number of 2A, as necessary) having the rated voltage of 6V is provided with the single protrusion 23A. The plug 2 (designated by the reference number of 2B, as necessary) having the rated voltage of 12V is provided with the single protrusion 23B. The plug 2 (designated by the reference number of 2C, as necessary) having the rated voltage of 24V is provided with the single protrusion 23C. The plug 2 (designated by the reference number of 2D, as necessary) having the rated voltage of 48V is provided with the single protrusion 23D.

Next, an explanation is made to an operation of the output receptacle 1 when the plug 2 is connected thereto. The operation pieces 17a of each of the voltage switches 17A to 17D are not pressed until the plug 2 is connected to the output receptacle 1. Therefore, each of the voltage switches 17 is kept turned off. Thus, the DC/DC converter 15 applies no DC voltage between the blade reception members 13 and 14 in the pair.

When the plug 2A is connected to the output receptacle 1, the protrusion 23A presses the operation piece 17a of the voltage switch 17A. Thus, only the voltage switch 17A is turned on. Accordingly, the DC/DC converter 15 applies the potential of 6V to the second blade reception member 14. As a result, the voltage of 48V is applied between the blade reception members 13 and 14 in the pair. When the plug 2B is connected to the output receptacle 1, the protrusion 23B presses the operation piece 17a of the voltage switch 17B. Thus, only the voltage switch 17B is turned on. As a result, the voltage of 12V is applied between the blade reception members 13 and 14 in the pair. When the plug 2C is connected to the output receptacle 1, the protrusion 23C presses the operation piece 17a of the voltage switch 17C. Thus, only the voltage switch 17C is turned on. As a result, the voltage of 24V is applied between the blade reception members 13 and 14 in the pair. When the plug 2D is connected to the output receptacle 1, the protrusion 23D presses the operation piece 17a of the voltage switch 17D. Thus, only the voltage switch 17D is turned on. As a result, the voltage of 48V is applied between the blade reception members 13 and 14 in the pair. As described in the above, the plug 2 is supplied with the DC voltage corresponding to its rated voltage.

In the aforementioned output receptacle 1, the voltage switches 17A to 17D constitute the voltage selection unit configured to select the DC voltage applied between the blade reception members 13 and 14 in the pair. When the plug 2 is connected to the output receptacle 1, the protrusion 23 acts in cooperation with the voltage switches 17A and 17B of the voltage selection unit for selection of a voltage designated by the rated voltage of the plug 2.

As described in the above, the output receptacle 1 of the present embodiment provides the same advantage as that of the third embodiment.

FIG. 8D exemplifies a structure in which the operation piece 17a of the voltage switch 17 is pressed from the front side of the housing 10. However, as shown in FIG. 8E, the output receptacle 1 can have the operation piece 17a configured to be pressed from the lateral side of the housing 10.

Although, the first, second, third, and fourth embodiments respectively exemplify the output receptacle 1 designed to be connected to the DC voltage source, the output receptacle 1 may be designed to be connected to an AC voltage source. In this case, it is sufficient that the output receptacle 1 includes an AC/DC converter (not shown) provided to a power line between the terminal unit 16 and the DC/DC converter 15 thereof. Alternatively, the output receptacle 1 may be configured to supply an AC voltage to the plug 2. In this case, an AC/AC converter is utilized instead of the DC/DC converter 15. In the case that the AC voltage source provides the voltage of 100V or 230V and the plug 2 is supplied with the voltage equal to or less than 48V, the AC/AC converter is preferred to employ an electrical insulation transformer.

The above-mentioned combination output receptacle and plugs of the present invention can be used in a DC distribution system shown in FIG. 10, for example. In FIG. 10, a house H of a single-family dwelling is exemplified as a building where the DC distribution system is applied. However, the DC distribution system can be applied to a housing complex.

There are a DC power supply unit 101 configured to output DC power and the DC device 102 placed in the house H. The DC device 102 is a load activated by DC power. DC power is supplied to the DC device 102 via a DC supply line Wdc connected to an output terminal of the DC power supply unit 101. There is a DC breaker 114 interposed between the DC power supply unit 101 and the DC device 102. The DC breaker 114 is configured to monitor current flowing through the DC supply line Wdc and to limit or terminate electrical power supply from the DC power supply unit 101 to the DC device 102 via the DC supply line Wdc upon detecting an abnormal state.

The DC supply line Wdc is adopted as a power line for DC power as well as a communication line. For example, it is possible to communicate between devices connected to the DC supply line Wdc by means of superimposing on a DC voltage a communication signal used for transmitting a data and made of a high-frequency carrier. This technique is similar to a power line communication technique where a communication signal is superimposed on an AC voltage applied to a power line for supplying an AC power.

The aforementioned DC supply line Wdc is connected to an information breaker 116 via the DC power supply unit 101. The information breaker 116 is a primary device for constructing a home communication network (hereinafter called “home network”). The information breaker 116 is configured to communicate with a subsystem constructed by the DC device 102 in the home network, for example.

In the instance shown in FIG. 10, an information system K101, lighting systems K102 and K105, an entrance system K103, and a home alarm system K104 are adopted as the subsystem. The each subsystem is an autonomous distributed system, and operates by itself. The subsystem is not limited to the aforementioned instance.

The DC breaker 114 is associated with the subsystem. In the instance shown in FIG. 10, each of the information system K101, a pair of the lighting system K102 and entrance system K103, the home alarm system K104, and the lighting system K105 is associated with one DC breaker 114. A connection box 121 is provided to associate one DC breaker 114 with a plurality of the subsystems. The connection box 121 is configured to divide a system of the DC supply line for each subsystem. In the instance shown in FIG. 10, the connection box 121 is interposed between the lighting system K102 and the entrance system K103.

The information system K101 includes the informational DC device 102 such as a personal computer, a wireless access point, a router, and an IP telephone transceiver. This DC device 102 is connected to a DC socket 131 preliminarily provided to the house H (provided at the time of constructing the house H) as a wall outlet or a floor outlet, for example.

Each of the lighting systems K102 and K105 includes the lighting DC device 102 such as a lighting fixture. In the instance shown in FIG. 7, the lighting system K102 includes the lighting fixture (DC device 102) preliminarily provided to the house H. It is possible to send a control instruction to the lighting fixture of the lighting system K102 by use of an infrared remote controller. Further, the control instruction can be sent by transmitting a communication signal from a switch 141 connected to the DC supply line Wdc. In short, the switch 114 has a function of communicating with the DC device 102. In addition, the control instruction can be sent by transmitting a communication signal from the home server 116 or other DC device 102 of the home network. The control instruction for the lighting fixture indicates such as turning on, turning off, dimming, and blinking. Meanwhile, the lighting system K105 includes the lighting fixture (DC device 102) connected to a ceiling-mounted hooking receptacle 133 preliminarily provided on a ceiling. It is noted that the lighting fixture is attached to the ceiling-mounted hooking receptacle 133 by a contractor at the time of constructing an interior of the house H or attached to the ceiling outlet 133 by a resident of the house H.

The entrance system K103 includes the DC device 102 configured to respond to a visitor and to monitor an intruder.

The home alarm system K104 includes the alarming DC device 102 such as a fire alarm.

Any DC device 102 can be connected to each of the aforementioned DC outlet 131 and ceiling-mounted hooking outlet 133. Each of the DC outlet 131 and ceiling-mounted hooking receptacle 133 outputs DC power to the connected DC device 102. Therefore, the DC outlet 131 and ceiling-mounted hooking receptacle 133 are hereinafter collectively called the “DC outlet”, when a distinction between the DC outlet 131 and the ceiling-mounted hooking receptacle 133 is unnecessary. A case of the DC outlet has a connection slot (plug-in connection slot) for inserting a terminal of the DC device 102. A terminal receiving member configured to directly contact to the terminal which is inserted into the connection slot is housed in the case of the DC outlet. In short, the DC outlet with above mentioned configuration makes contact-type power supply. The DC device with a communication function is capable of transmitting a communication signal via the DC supply line Wdc. The communication function is provided to not only the DC device 102 but also DC outlet. It is noted that the terminal is directly attached to the DC device 102 or is attached to the DC device 102 via a connection wire.

The information breaker 116 is connected to not only the home network but also the wide area network NT constructing Internet. While the information breaker 116 is connected to the wide area network NT, a user can enjoy service provided by a center server (computer server) 200 connected to the wide area network. The information breaker 116 is connected to the wide area network NT via a router (not shown) having a function of a DHCP server.

The center server 200 provides service capable of monitoring or controlling a device (which is mainly the DC device 102, but which may be other apparatus having a communication function) connected to the home network via the wide area network NT, for example. The service enables monitoring or controlling a device connected to the home network by use of a communication terminal (not shown) having a browsing function such as a personal computer, an internet TV, and a mobile telephone equipment.

The information breaker 116 has a function of a communication middleware for communicating with the center server 200 and a function of a network security for connecting the wide area network NT. The information breaker 116 further has a function of time synchronization and a function of collecting identification information (assumed as “IP address” in this instance) concerning a device connected to the home network.

The communication middleware need have both a function of communicating with the center server 200 connected to the wide area network NT and a function of communicating with a device connected to the home network.

Now, an explanation is made to the function of communicating with the center server 200. The home device establishes periodically one-way polling communication, thereby verifying whether or not contents are stored in the center server 200. The center server 200 generates and stores contents upon receiving a monitoring request or controlling request from an information terminal connected to the wide area network NT. When the home device establishes the one-way polling communication while contents are stored in the center server 200, the center server 200 transmits the monitoring request or controlling request to the home device. Upon receiving a response to this request, the center server transmits the response to the information terminal. Accordingly, it is possible to monitor or control the home device by use of the information terminal.

When an event (such as fire detection) of which the home device should notify the information terminal occurs, the home device notifies the center server 200 of occurrence of the event. When the center server 200 is notified of the occurrence of the event by the home device, the center server 200 notifies the information terminal of the occurrence of the event by use of an e-mail. It is noted that a signal transmitted to the center server 200 is encrypted by means of SSL (Secure Sockets Layer Protocol). Further, the center server 200 is multiplexed such that one center server 200 functions instead of another center server 200 suffering from a communication error.

A function of communicating with the home network of the information breaker 116 includes an important function of detecting and managing a device constructing the home network. By means of utilizing UPnP (Universal Plug and Pray), the information breaker 116 automatically detects a device connected to the home network. The information breaker 116 further includes a display device 117 having a browsing function, and controls the display device 117 to display a list of the detected device. The display device 117 includes a touch panel or another user interface unit. Therefore, it is possible to select a desired one from options displayed on a screen of the display device 117. Accordingly, a user (a contractor or a resident) of the information breaker 116 can monitor and control the device through the screen of the display device 117. The display device 117 may be separated from the information breaker 116.

Each device connected to the home network is configured to transmit an entry packet upon entering the home network (upon being connected to the home network or upon activating after being connected to the home network). The information breaker 116 receives the enter packet, thereby determining types or functions of the device entering the home network. The device sets automatically own address (e.g. IP address). When a DHCP server is provided, the device obtains own address from the DHCP server. Moreover, each device has a function of transmitting an existence acknowledgement response packet. Upon receiving an existence acknowledgement packet from the information breaker 116, the device judges whether or not own configuration (e.g. own address) has been changed. Upon judging that own configuration has been changed, the device transmits the existence acknowledgement response packet including a state variation notification flag.

The information breaker 116 manages information with relation to connection of a device. For example, the information breaker 116 stores types or functions and an address of the device connected to the home network by receiving the entry packet and existence acknowledgement response packet.

When an event occurs at a device connected to the home network, occurrence of the event is notified the information breaker 116 of. In this case the information breaker 116 establishes a unicast communication to transmit an event packet generated at an application layer to the device under control of the information breaker 116 with reference to types or functions of the device. The device judges contents of the event packet transmitted from the information breaker 116. The device operates corresponding to the event packet when the contents of the event packet are important, and the device discards the event packet when the contents of the event packet are dispensable. Accordingly, the devices connected to the home network can make a linked operation. For example, a lighting fixture, which is one of the devices, is caused to turn on and off by manipulation of a switch, which is another of the devices.

Further, in order to make the cooperative operation of the devices, an information terminal such as a personal computer may be connected to the home server 116 and an association between the devices can be made by use of a browsing function of the information terminal. Each of the devices holds a relation with regard to the linked operation between the devices. Therefore, the devices can make the linked operation without requiring to access to the information breaker 116. After establishing an association with regard to the linked operation of respective devices, a lighting fixture, which is one of the devices, is caused to turn on and off by manipulation of a switch, which is another of the devices, for example. Although the association with regard to the linked operation is made for devices belonging to the same subsystem, the association with regard to the linked operation may be made for devices belonging to the different subsystems. For example, when the home alarm system K104 detects a fire, the lighting system K102 can be blinked in order to alert a resident, or can be turned on in order to indicate an escape route.

Next, a brief explanation is made to a network security function of the information breaker 116. The center server 200 communicates with the home devices via the information breaker 116. The information breaker 116 controls a session of a communication between the home device and the center server 200 by use of a fire wall function corresponding to the SPI (Stateful Packet Inspection). Therefore, the information breaker 116 detects an unauthorized access from the wide area network NT, and discards an unauthorized packet. The information breaker 116 further limits access by use of a MAC address, thereby banning access from an unregistered information terminal.

As explained in the above, the information breaker 116 provides a service managing for the cooperative operation of the devices connected to the home network and a service monitoring and controlling the device by use of the information terminal having the browsing function. In short, the information breaker 116 functions as a home server for the home network.

The DC supply unit 101 is configured to basically generate DC power from AC power supplied from an AC power source (for example a commercial power source located outside) AC. In the instance shown in FIG. 10, the AC power source AC is connected to an AC/DC converter 112 including a switching regulator via a main breaker 111. The main breaker 111 is embedded in a distribution board 110. DC power output from the AC/DC converter 112 is supplied to each DC breaker 114 via a cooperation control unit 113.

The DC supply unit 101 is provided with a secondary cell 162 in view of a period (blackout period of the commercial power source) in which the DC supply unit 101 fails to receive electrical power from the AC power source AC. A solar cell 161 and fuel cell 163 configured to generate DC power can be used together with the secondary cell 162. The solar cell 161, secondary cell 162, and fuel cell 163 respectively are a dispersed power source in view of a main power source including the AC/DC converter 112. In the instance shown in FIG. 10, the solar cell 161, secondary cell 162, and fuel cell 163 respectively include a circuit unit configured to control its output voltage. The solar cell 161 further includes not only a circuit unit of controlling electrical discharge but also a circuit unit of controlling electrical charge.

Although the solar cell 161 and fuel cell 163 of the dispersed power sources are dispensable, the secondary cell 162 is preferred to be provided. The secondary cell 162 is charged by the main power source or the other dispersed power source at the right time. The secondary cell 162 is discharged during a period in which the DC supply unit 101 fails to receive electrical power from the AC power source AC. In addition, the secondary cell 162 is discharged at the right time as necessary. The cooperation control unit 113 is configured to control discharge and charge of the secondary cell 162 and to make cooperation between the main power source and the dispersed power source. In short, the cooperation control unit 113 functions as a DC power control unit configured to control distributing to the DC device 102 electrical power from the main power source and dispersed power source constituting the DC supply unit 101. It is noted that DC power from the solar cell 161, secondary cell 162, and fuel cell 163 may be input to the AC/DC converter 112 by converting into AC power.

A drive voltage of the DC device 102 is selected from different voltages (e.g. 5V, 12V, 24V, 48V, and the like) respectively suitable to individual devices of different voltage requirements. For this purpose, the cooperation control unit 113 is preferred to include a DC/DC converter configured to convert DC voltage from the main power source and dispersed power source into a desired voltage. Normally, a fixed voltage is applied to one subsystem (or the DC device 102 connected to one particular DC breaker 114). However, different voltages may be selectively applied to one subsystem by use of three or more lines. Use of two wired DC supply line Wdc can vary the voltage applied between wires with time. The DC/DC converter can be placed at plural points in a similar fashion as the DC breakers.

The aforementioned DC voltage applied via the DC supply line Wdc is lower in voltage than the AC power source AC such as a commercial power source. The single DC supply line Wdc has an upper limit of current flowing therethrough. Therefore, it is difficult to supply enough power to a home electrical device having relatively high power consumption from the DC power source. Especially, in the case of a high power electrical device (e.g. a laundry machine and the like), a heat generating electrical device (e.g. a rice cooker, a microwave oven, and the like), and a big-screen TV receiver, the AC power is required.

These types of the electrical device is supplied the AC power to via an AC supply line (not shown) connected to a branch breaker (not shown) which is placed in the distribution panel 110 together with the main breaker 111. The AC supply line is connected to an outlet (not shown) preliminarily provided as a wall outlet, a floor outlet, or a ceiling-mounted hooking receptacle, for example. The electric device is connected to a power cord having a power plug (not shown) and is supplied AC power by connecting the power plug to the outlet. It is noted that the DC breaker 114 may have a function of communicating with the electrical device K101 or the outlet via the AC supply line. With the inclusion of this function, the home network can be extended to cover an electric device activated by the AC power.

In the instance shown in FIG. 10, only one AC/DC converter 112 is provided. However, a plurality of AC/DC converters 112 may be connected in parallel to each other. When the plurality of the AC/DC converters 112 is provided, it is preferred to vary the number of the AC/DC converters 112 being activated in accordance with a magnitude of the load.

The aforementioned AC/DC converter 112, cooperation control unit 113, DC breaker 114, solar cell 161, secondary cell 162, and fuel cell 163 respectively are provided with a communication function. Therefore, the linked operation can be performed in response to status of each of the main power source, dispersed power source, and loads including the DC device 102. Like a communication signal used for the DC device 102, a communication signal used by the communication function is transmitted by being superimposed on DC voltage.

In the instance shown in FIG. 10, in order to convert AC power output from the main breaker 111 into DC power, the AC/DC converter 112 is placed in the distribution panel 110. However, the AC/DC converter 112 is not necessarily placed in the distribution panel 110. For example, branch breakers (not shown) may be connected to an output side of the main breaker 111 in the distribution panel 110 such that a plurality of systems is branched off from an AC supply line, and an AC/DC converter may be provided to an AC supply line of each of the systems. That is, each system may be provided with an apparatus configured to convert AC power into DC power. In this instance, it is possible to provide the DC supply unit 101 to each unit such as a floor or room of the house H. Accordingly, it is possible to manage the DC supply unit 101 for each system. In addition, it is possible to shorten a distance between the DC supply unit 101 and the DC device 102 configured to utilize DC power. Therefore, it is possible to reduce power loss caused by a voltage drop which occurs in the DC supply line Wdc. Alternatively, the main breaker 111 and branch breaker may be housed in the distribution panel 110, and the AC/DC converter 112, cooperative control unit 113, DC breaker 114, and home server 116 may be placed in another panel different from the distribution panel 110.

1. A combination output receptacle and plugs for providing different DC voltages from an output receptacle respectively to different plugs selectively connected to said output receptacle,
each of said plugs being provided with two-pole blades adapted to be connected respectively to two-pole blade reception members of said output receptacle,
said two-pole blade reception members comprising a first blade reception member adapted to be supplied with a zero voltage and at least two second blade reception members adapted to be supplied with different voltages,
said two-pole second blade reception members being arranged to be shaped or located differently from each other, and
said two-pole blades of each of said at least two plugs comprising a first blade configured to be connected to said first blade reception member, and a second blade,
said second blades of at least two plugs being shaped or located differently from each other for connection respectively to said second blade reception members.

2. A combination output receptacle and plugs for providing different DC voltages from an output receptacle respectively to different plugs selectively connected to said output receptacle,
each of said plugs being provided with two-pole blades adapted to be connected respectively to two-pole blade reception members of said output receptacle,
said output receptacle being provided with a voltage switch configured to select one of the different DC voltages being supplied across said two-pole blade reception members,
said plugs being provided respectively with projections which come into contact with said voltage switch when said two-pole blades are connected to said two-pole blade reception members,
said projections of the plugs being shaped or located differently from each other,
said voltage switch being configured to select a proper one from said different DC voltage depending on the shape or location of the projection of the plug in contact with said voltage switch.

3. A combination output receptacle and plugs as set forth in claim 2,
wherein said combination output receptacle and plugs comprising a plurality of said voltage switches located in differently from each other depending on a DC voltage to be switched, and
said protrusion being shaped or located to be contacted to said voltage switch corresponding to the proper DC voltage while said blades of said plug are respectively connected to said blade reception members of said output receptacle.

4. A combination output receptacle and plugs comprising:
a plug including a first blade and a second blade; and
an output receptacle configured to be connected to said plug and including a first blade reception member configured to be connected to said first blade of said plug and a second blade reception member configured to be connected to said second blade of said plug,
wherein said output receptacle includes a plurality of said second blade reception members,
said first blade reception member adapted to be supplied with a reference potential,
said plurality of said second blade reception members adapted to be supplied with different potentials, and
said second blade being configured to be connected to any one of said plurality of said second blade reception members in accordance with a rated voltage of said plug.

5. A combination output receptacle and plugs comprising:
a plug including a pair of blades; and
an output receptacle including a pair of blade reception members adapted in use to be respectively connected to said pair of said blades,
wherein said output receptacle includes a voltage selection unit configured to select a DC voltage applied between said blade reception members in said pair, said output receptacle being configured to apply the DC voltage selected by said voltage selection unit between said blade reception members in said pair, and
said plug including an operation unit configured to operate said voltage selection unit to select a voltage according to a rated voltage of said plug when said plug is connected to said output receptacle.

6. A combination output receptacle and plugs as set forth in claim 5, wherein
said voltage selection unit includes a plurality of voltage switches and is configured to select the DC voltage in accordance with on/off states of each of said voltage switches, and
said operation unit being configured to switch the on/off states of said voltage switches when said plug is connected to said output receptacle.
